(19) United States
(12) Patent Application Publication
(10) Pub. No.: US 2025/0018625 A1
(43) Pub. Date: Jan. 16, 2025

(54) CARRIER OVER FABRIC

(71) Applicant: ILLINOIS TOOL WORKS INC., GLENVIEW, IL (US)

(72) Inventors: CRAIG M. OOMEN, ROCKFORD, MI (US); SAMUEL SMITH, ALLENDALE, MI (US); ROBERT A. BRATTY, ROCKFORD, MI (US); RICHARD VANDEKOPPLE, ROCKFORD, MI (US); KELLY WASHBURN, ALLEGAN, MI (US); RANDY SAYERS, BELDING, MI (US)

(21) Appl. No.: 18/762,233

(22) Filed: Jul. 2, 2024

Related U.S. Application Data
(60) Provisional application No. 63/533,497, filed on Aug. 18, 2023.
(60) Provisional application No. 63/525,759, filed on Jul. 10, 2023.

(51) Int. Cl. B29C 45/14; A47C 7/14; B29C 45/00; B29C 45/73; B29K 21/00; B29K 105/08; B29L 31/00

(52) U.S. Cl. CPC B29C 45/14262; A47C 7/14; B29C 45/0025; B29C 45/14336; B29C 45/14786; B29C 2045/0034; B29C 45/73; B29K 2021/003; B29K 2105/0836; B29L 2031/771

(57) ABSTRACT

A seat assembly includes a fabric component having a seat surface and a carrier attached to the fabric component. The carrier includes a variable thickness along the perimeter of the carrier. The fabric component includes two or more tension zones.

### CROSS-REFERENCE TO RELATED APPLICATIONS

This application claims the benefit of and priority to U.S. Provisional Patent Application No. 63/525,759, filed on Jul. 10, 2023, and entitled “FRAME OVER FABRIC WITH FLEX RETURN FLANGE,” and U.S. Provisional Patent Application No. 63/533,497, filed on Aug. 18, 2023, and entitled “FRAME OVER FABRIC,” each of which being incorporated by reference herein in its entirety.

### BACKGROUND

### Field of the Disclosure

Examples of the present disclosure generally relate to a fabric suspension seat structure, and more particularly, to a fabric suspension seat structure having a molded carrier.

### Description of the Background of Disclosure

Seat assemblies, such as office furniture, often use a fabric suspension structure. Typically, a fabric suspension seat structure includes a support carrier disposed along a perimeter of a fabric. The fabric extends across the support carrier to provide a surface on which a user can sit. The fabric often secures to the support carrier that is then attached to a support frame that couples the suspension structure to the furniture. In order to provide proper suspension, the fabric is stretched and the carrier is then overmolded to the fabric. Current methods of stretching the fabric prior to overmolding require clamps and a variety of motors to pull the fabric taught; however, such clamps and motors can be costly to buy, install, and maintain.

### SUMMARY

In some aspects, a seat assembly includes a fabric component that defines a seat surface and a carrier that is molded to the fabric component. The carrier includes a curved parting line that circumscribes a perimeter of the carrier. The fabric component includes a plurality of tension zones. The two or more tension zones can translate to a plurality of compressible soft zones and a plurality of firm comfort zones.

In some embodiments, the carrier includes an upper section and a lower section, with the parting line disposed therebetween. In some embodiments, the distance between an upper surface of the upper section, opposite the parting line, and the parting line is variable along the parting line. In some embodiments, the thickness of the upper section or the lower section is variable along a perimeter of the respective section. In some embodiments, the fabric component at least partially comprises a resin material. In some embodiments, the carrier at least partially comprises a material having a melting temperature that is greater than a melting temperature of the material of the fabric component. In some embodiments, two of the tension zones are configured to receive and support different amounts of weight. In some embodiments, the fabric is pre-tensioned prior to the molding of the carrier to the fabric. In some embodiments, the curved parting line defines a plurality of inflection points.

In some aspects, a seat assembly includes a fabric component having a seat surface and a carrier molded to the fabric component. The carrier includes a curved parting line along a perimeter of the carrier, and the curved parting line defines a plurality of inflection points. In some embodiments, the fabric component includes a plurality of tension zones resulting from the curved parting line. In some embodiments, two of the tension zones are configured to receive and support different amounts of weight. In some embodiments, the carrier comprises an upper section and a lower section, with the parting line disposed therebetween. In some embodiments, the thickness of the upper section or the lower section is variable along a perimeter of the respective section. In some embodiments, the fabric component is knit.

In some aspects, a method of manufacturing includes tensioning a fabric component between a first mold base and a second mold base, and molding a carrier onto the fabric component. The carrier includes a curved parting line around a perimeter of the carrier, and the fabric is tensioned to include a plurality of tension zones. In some embodiments, the carrier comprises an upper section and a lower section, with the parting line disposed therebetween. In some embodiments, the height of the first mold base or the second mold base is variable. In some embodiments, the carrier is formed within a cavity defined between the first mold base or the second mold base. In some embodiments, the curved parting line is formed by an undulating cavity between the first mold base or the second mold base.

### DESCRIPTION OF THE DRAWINGS

FIG. 1 is a perspective view of one example of components of a seat assembly;

FIG. 2 is a perspective view of the components of the seat assembly of FIG. 1;

FIG. 3 is a perspective view of a mold for the manufacturing of the seat assembly of FIG. 1;

FIG. 4 is a perspective view of the mold for the manufacturing of the seat assembly of FIG. 1; and

FIG. 5 is a diagram of a simplified example of a molding process for manufacturing a seat assembly.

### DETAILED DESCRIPTION

Examples of the present disclosure provide a seat assembly including a fabric and a carrier. A flexible or rigid carrier is configured to be directly molded to a perimeter section of the fabric component. In some examples, the carrier may include a variable elevation or parting line position around a perimeter of the carrier. In this manner, the seat assembly may distribute stress during loading of the fabric component variably as needed to manage comfort targets, as well as various body shapes and sizes.

Examples of the present disclosure further provide a method of overmolding the variable thickness carrier to the fabric without the need of exterior clamps, mold cores, lifters or motors to pre-stretch the fabric. Although the method described below does not need clamps, mold cores, lifters, or motors to stretch the fabric prior to the overmolding process, it is contemplated that an exterior clamping assembly may still be utilized.

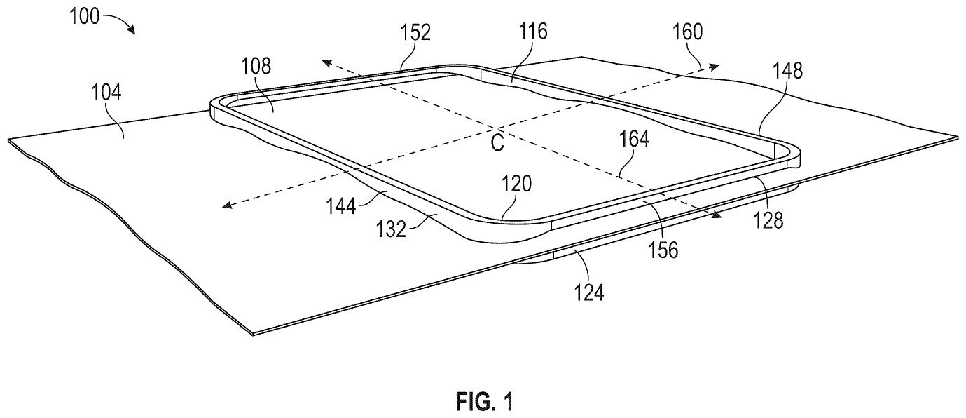

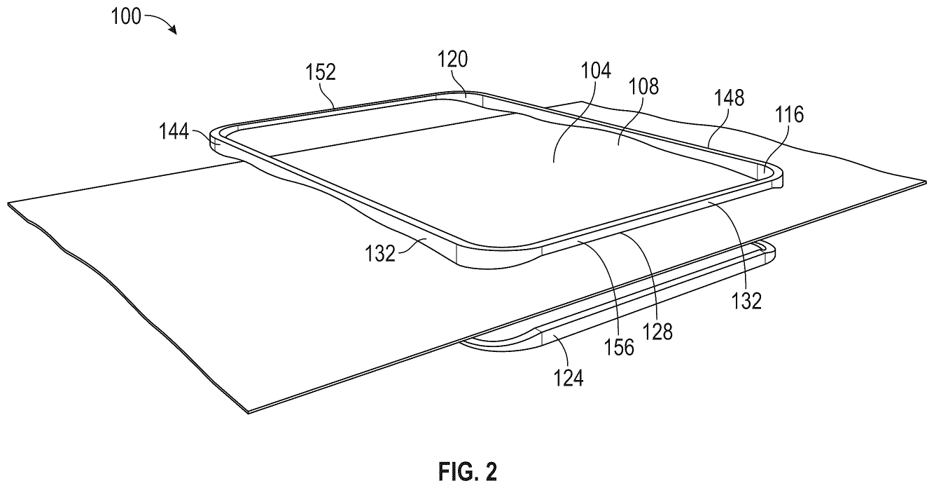

With reference to FIGS. 1 and 2, in one aspect, a seat assembly 100 is shown that comprises a fabric component 104, or seat member. The fabric component 104 has a top surface 108 opposite a bottom surface and extends across a carrier 116, or carrier member, such that the fabric component 104 is stretched or tensioned to provide the top surface 108, or a seat surface, in a suspended state and capable of supporting a user in a seated position.

As shown in FIGS. 1 and 2, the fabric component 104 comprises a plurality of fibers that are woven or arranged together, with all or some of the fibers being formed of a flexible material or resin. For example, the fabric component 104 may comprise a knitted component, a woven textile, a non-woven textile, leather, synthetic leather, mesh, suede, and/or a combination of one or more of the aforementioned materials. The fabric component 104 may be formed by way of warp knitting, weft knitting, flat knitting, circular knitting, and/or other suitable knitting operations. The fabric component 104 may have a plain knit structure, a mesh knit structure, and/or a rib knit structure, for example. Woven textiles include, but are not limited to, textiles formed by way of any of the numerous weave forms, such as plain weave, twill weave, satin weave, dobbin weave, jacquard weave, double weaves, and/or double-cloth weaves, for example. Non-woven textiles include textiles made by air-laid and/or spun-laid methods, for example. The fabric component 104 may comprise a variety of materials that may have varying properties or visual characteristics. For example, some or all of the fibers of the fabric component 104 may be formed of a fiberglass or a thermoplastic material or resin, or a combination thereof. The plurality of fibers may be bonded or fastened together and oriented lengthwise with respect to one another and along a fore-to-aft length of the carrier 116 or a side-to-side length of the carrier116. The melting temperature of the fabric component 104 depends at least in part on the selection or combination of material or resin of the plurality of fibers, which may be configured to have a low average melting temperature relative to the average melting temperature of the material of the carrier 116.

With continued reference to FIGS. 1 and 2, the carrier 116 comprises an upper carrier section 120 and a lower carrier section 124. As described further below, the upper carrier section 120 and the lower carrier section 124 can be pressured against one another to tension the fabric 104. In some embodiments, the upper carrier section 120 includes a variable elevation or topography edge 128. The topography edge 128 faces the lower carrier section 124. The topography edge 128 extends from a mid-segment 132 of the upper carrier section 120 that varies in thickness and shape along the carrier 116. Consequently, when viewed from the side the topography edge 128 defines curves or undulations therealong. It is appreciated that the lower carrier section 124 can similarly define a variable thickness around a perimeter of the lower carrier section 124. However, in some embodiments, the lower carrier section 124 defines a uniform thickness. As described further below, in some embodiments the upper carrier section 120 is bonded to the lower carrier section 124 to form the carrier 116. The fabric 104 is tensioned between the upper carrier section 120 and the lower carrier section 124. The fabric 104 may form a parting line between the upper carrier section 120 and the lower carrier section 124 (e.g., at the topography edge 128). Due to the variable thickness of the upper and/or lower carrier section 124 the parting line therebetween is curved, defining a variable distance between the parting line and an upper surface of the upper carrier section 120 (e.g., a surface opposite the topography edge 128). In some embodiments, the curvature of the parting line defines a plurality of inflection points. In some embodiments, the parting line is symmetrical about one or more axes (e.g., a center axis) of the carrier 116. In other embodiments, the parting line is asymmetric.

The carrier 116 may be integrally formed of a material or resin or a combination thereof that can comprise a resilient polymer such as any thermoplastic. For example, the thermoplastic can include nylon, glass-filled nylon, polypropylene, acetyl, or polycarbonate; any thermal set material, including polyesters and epoxies; or any resin-based composites, including carbon fiber or fiberglass, thereby allowing the carrier 116 to conform and move in response to force exerted by a user. The carrier 116 may be formed from a wide variety of polymeric materials, including, for example, polyethylene (PE), low density polyethylene (LDPE), high density polyethylene (HDPE), polyethylene terephthalate (PET), crystalline PET, amorphous PET, polyethylene glycol terephthalate, polystyrene (PS), polyamide (PA), polyvinyl chloride (PVC), polycarbonate (PC), poly(styrene: acrylonitrile) (SAN), polymethylmethacrylate (PMMA), polypropylene (PP), polyethylene naphthalene (PEN), polyethylene furanoate (PEF), PET homopolymers, PEN copolymers, PET/PEN resin blends, PEN homopolymers, overmolded thermoplastic elastomers (TPE), fluropolymers, polysulphones, polyimides, cellulose acetate, Silicone, PBT and/or combinations thereof.

Referring to FIGS. 1 and 2, the carrier 116 includes a front end 144, a rear end 148, a left end 152, and a right end 156. A longitudinal axis 160 extends from a front end 144 to a rear end 148 and further defines a vertical plane that bisects the seat assembly 100 and a horizontal plane that is coplanar with the top surface 108 of the fabric component 104. A transverse axis 164 extends coplanar with and perpendicular to the longitudinal axis 160 from a left end 152 to a right end 156 of the carrier 116, and further defines a vertical plane that bisects the seat assembly 100. As such, an intersection between the longitudinal axis 160 and the transverse axis 164 defines a central point C of the seat assembly 100.

As shown in FIGS. 1 and 2, the carrier 116 is symmetric about the longitudinal axis 160, such that the shape and size of the carrier 116 at the right end 156 is mirrored by the shape and size of the carrier 116 at the left end 152. In the illustrated example, the carrier 116 is also symmetric about the transverse axis 164, such that the shape and size of the carrier 116 at the front end 144 is mirrored by the shape and size of the carrier 116 at the rear end 148. However, in some embodiments, the shape and size of the carrier 116 at the front end 144 is different from the shape and size of the carrier 116 at the rear end 148, such that the carrier 116 is asymmetrical about the transverse axis 164.

As depicted in FIGS. 1 and 2, the upper carrier section 120 varies in thickness and shape as it extends about the fabric component 104. The fabric component 104 is tensioned between the front end 144 and the rear end 148 and, further, between the left end 152 and the right end 156 of the carrier 116. Specifically, the non-uniformity of the topographical edge 128, and the variable thickness of the upper carrier section 120 and/or the lower carrier section 124 can uniquely tension the fabric component 104. Consequently, the fabric component 104 is tensioned and resilient in multiple, opposing directions defining equal and opposite force vectors between the fabric component 104 and the carrier 116. Accordingly, the fabric component is molded to the carrier 116 to provide a suspension force that is configured to support a user when seated on the top surface 108 of the fabric component 104. The fabric component 104 may be substantially horizontal and planar in an unloaded state.

Due to the weight of a user when seated on the top surface 108 of the fabric component 104, the fabric component 104 flexes downwardly below the horizontal plane formed by the longitudinal axis 160, and below an upper surface of the upper carrier section 120 (e.g., opposite the topographical edge 128). In this manner, the fabric component 104 provides a suspension or hammock support for a user seated on the top surface 108. As described further below, the variation in the thickness of the upper and/or lower carrier section 120, 124, may aid in the creation of zonal tensioning. Specifically, the parting line disposed between the upper and lower carrier sections 120, 124 defines a variable elevation (e.g., a distance between the parting line and an uppermost or lowermost surface of the seat assembly 100), which leads to the creation of zonal tensioning. Zonal tensioning refers to zones or areas of the fabric component 104 that are tensioned or stretched differently to countermeasure the variable input forces from a mannequin or human occupant. For example, a zone meant to receive a human buttock may be tensioned differently than a zone meant to receive a human thigh.

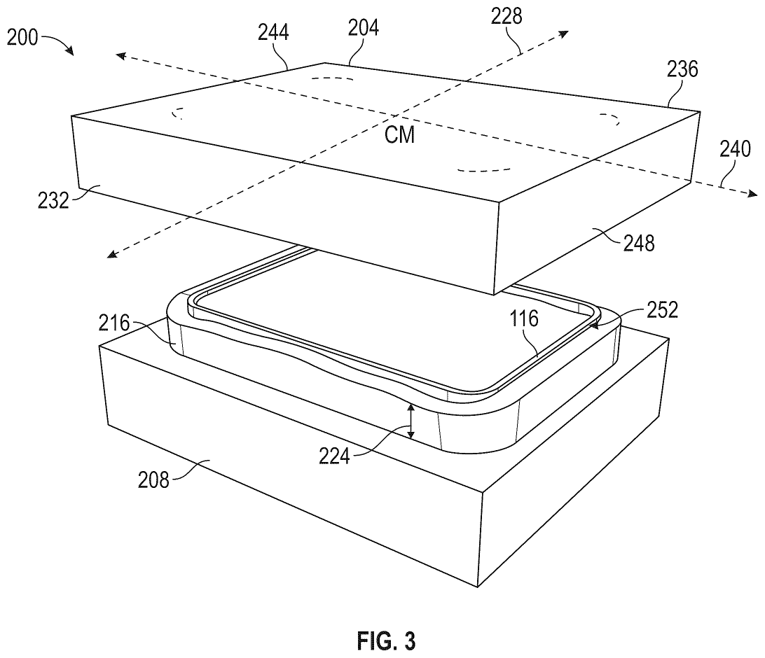

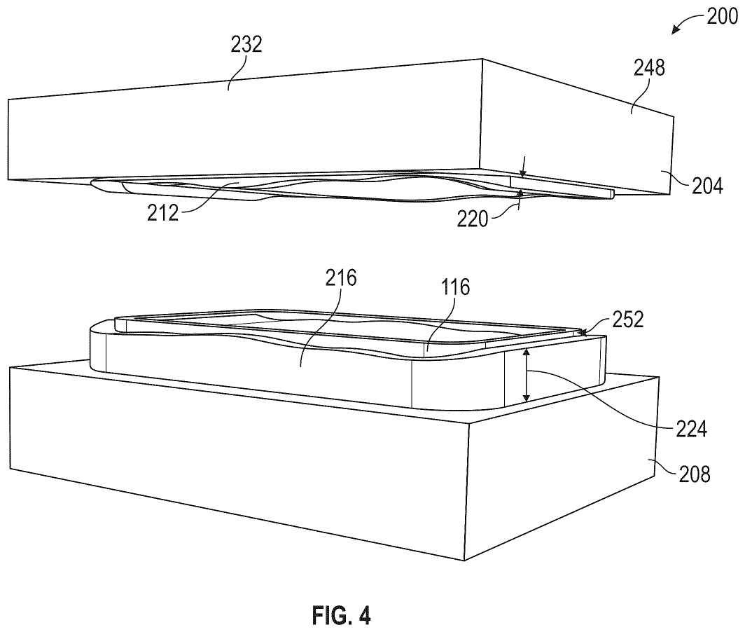

Referring now to FIGS. 3 and 4, a mold 200 is shown for overmolding the carrier 116 onto the fabric component 104. The mold 200 includes a first mold base 204 opposite a second mold base 208. The first mold base 204 includes a first mold core 212 and the second mold base 208 includes a second mold core 216. The first mold core 212 and the second mold core 216 extend from the first mold base 204 and the second mold base 208, and are configured to pinch and tension the fabric component 104 prior to and during the molding of the seat assembly 100. A perimeter shape of the first mold core 212 and the second mold core 216 may be similar to the shape of the carrier 116. In other embodiments, the perimeter shape of the first mold core 212 and the second mold core 216 may be dissimilar to the shape of the carrier 116.

As depicted in FIGS. 3 and 4, the first mold core 212 extends from the first mold base 204 at a first height 220. The first height 220 of the first mold core 212 can be variable around the perimeter of the first mold core 212, forming a continuous curve with one or more inflection points. The first mold base 204 therefore defines a variable height. Similarly, the second mold core 216 extends from the second mold base 208 at a second height 224. The second height 224 of the second mold core 216 can also be variable around the perimeter of the second mold core 216, forming a continuous curve with one or more inflection points. The second mold base 208 therefore defines a variable height. In some embodiments, the shape, height, and size of the second mold core 216 may be a negative of the shape, height, and size of the first mold core 212. The first mold core 212 and the second mold core 216 may therefore mesh together to form a seal.

One of the first mold core 212 or the second mold core 216 may be movable within the first mold base 204 or the second mold base 208, respectively. The first mold base 204 and the second mold base 208 may close by moving towards each other. In some embodiments, the first mold base 204 is moved toward the second mold 208, the second mold base 208 is moved toward the first mold base 204, or the first and second mold bases 204, 208 are moved toward one another. The first mold core 212 or the second mold core 216 may be movable within the mold 200, to allow the first mold core 212 or the second mold core 216 to collapse or retreat within the first mold base 204 or the second mold base 208. As the first mold base 204 and the second mold base 208 close, the first mold core 212 and the second mold core 216 contact one another, causing one of the first mold core 212 or the second mold core 216 to collapse or retreat within the first mold base 204 or the second mold base 208. The first mold core 212 or the second mold core 216 may be coupled to one or more springs, a hydraulic piston, an electric motor, or an electromagnet that first may first resist the movement of the first mold core 212 or the second mold core 216, and second may return the first mold core 212 or the second mold core 216 to an original position, once the mold 200 opens and the final product is released.

Referring to FIG. 3, a mold longitudinal axis 228 extends from a mold front end 232 to a mold rear end 236 and further defines a vertical plane that bisects the mold 200. A mold transverse axis 240 extends coplanar with and perpendicular to the mold longitudinal axis 228 from a mold left end 244 to a mold right end 248. As such, an intersection between the mold longitudinal axis 228 and the transverse axis 240 defines a central point CM of the mold.

Referring to FIG. 4, and similar to the carrier 116, the first mold core 212 and the second mold core 216 are symmetric about the longitudinal axis 228, such that the height, shape, and size of the first mold core 212 and the second mold core 216 at the mold right end 248 are mirrored by the height, shape, and size of the first mold core 212 and the second mold core 216 at the mold left end 244. However, in some embodiments, the first mold core 212 and the second mold core 216 are asymmetric about the longitudinal axis 228, such that the height, shape, and size of the first mold core 212 and the second mold core 216 at the mold right end 248 are not mirrored by the height, shape, and size of the first mold core 212 and the second mold core 216 at the mold left end 244. In the illustrated example, the first mold core 212 and the second mold core 216 are also symmetric about the mold transverse axis 240, such that the height, shape, and size of the first mold core 212 and the second mold core 216 at the mold front end 232 are mirrored by the height, shape, and size of the first mold core 212 and the second mold core 216 at the mold rear end 236. However, in some embodiments, the height, shape, and size of the first mold core 212 and the second mold core 216 at the mold front end 232 are different from the height, shape, and size of the first mold core 212 and the second mold core 216 at the mold rear end 236, such that the first mold core 212 and the second mold core 216 are asymmetric about the mold transverse axis 240.

Once the mold 200 is closed, the fabric component 104 is pinched between the first mold core 212 and the second mold core 216. The closed mold 200 forms a carrier cavity 252, between the first mold core 212 and the second mold core 216, configured to form the carrier 116 having the curved parting line. Specifically, similar to the height of the first and second mold bases 204, 208, and the curved parting line, the carrier cavity 252 undulates and defines multiple inflection points. Consequently, when the fabric component 104 is pinched between the first mold core 212 and the second mold core 216, the fabric component 104 is stretched and pre-tensioned across the carrier cavity 252. The carrier material is then injected into the carrier cavity 252 and can flow around and through the fabric component 104. Once the carrier material hardens into the carrier 116, the carrier 116 is chemically and mechanically bonded to the fabric component 104.

The various symmetries of the first mold core 212 and the second mold core 216 are configured to aid the molding of the carrier 116, described above, e.g., the variable thickness and shape as the carrier 116 extends about the fabric component 104. More specifically, as the carrier material is injected into the mold 200, the thickness of the upper carrier section 120 and the lower carrier section 124 may vary in a manner similar to the variation of the first height 220 and the second height 224 of the first mold core 212 and the second mold core 216. The various heights and shapes of the first mold core 212 and the second mold core 216 are further configured to provide zonal tensioning to the fabric component 104 prior to injection of the carrier material. Specifically, portions of the first mold core 212 and the second mold core 216 that are greater in height lead to higher tension zones while portions of the first mold core 212 and the second mold core 216 that are lesser in height lead to lower tension zones.

The seat assembly 100 is manufactured to form a plurality of tension zones (e.g., two, three, four, five, six, seven, eight, nine ten, or more tension zones) in the fabric 104. In some embodiments, each of the tension zones is configured to receive and support different amounts of weight or force. In some embodiments, two or more of the tension zones are configured to receive and support similar amounts of weight and force.

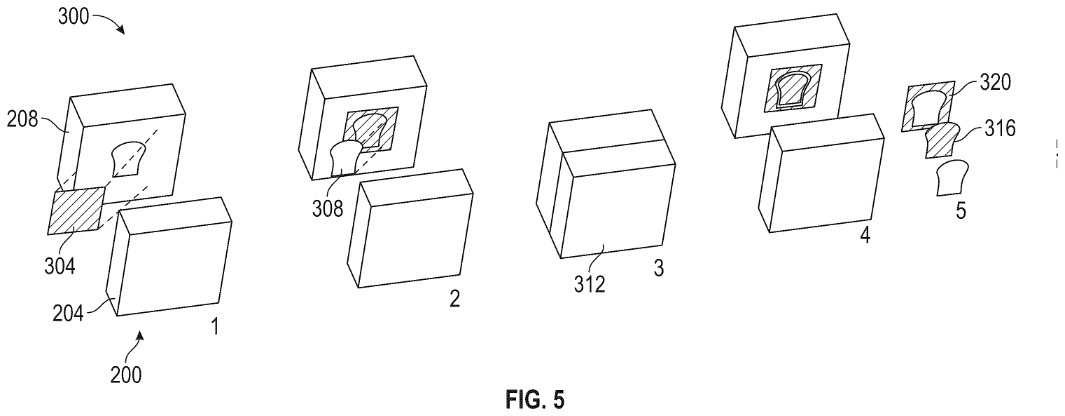

Referring to FIG. 5, an example of a molding process 300 is disclosed that may be used to attach a fabric blank 304, similar to the fabric component 104, to a carrier support, similar to the carrier 116. It is contemplated that the seat assembly 100 may be manufactured in various ways or steps and by using various machinery or materials, such as those described in U.S. Pat. No. 7,618,572, entitled “Method and Apparatus for Manufacturing Load Bearing Fabric Support Structures,” U.S. Pat. No. 7,677,873, entitled “Apparatus and Method for Molding onto a Stretched Blank,” U.S. Pat. No. 8,066,501, entitled “Apparatus and Method for Molding onto a Stretched Blank,” and U.S. Pat. No. 9,156,211, entitled “Apparatus and Method for Manufacturing a Load Bearing Fabric Surface,” all of which are assigned to Illinois Tool Works Inc., and are hereby incorporated by reference in their entirety. It is further contemplated that various alternative methods of manufacturing can be used to manufacture the seat assembly 100, such as types of additive manufacturing or subtractive manufacturing.

As illustrated in FIG. 5, the molding process 300 is depicted in a simplified manner having five stages, moving from left to right on the page, which will be referred to herein as a first, second, third, fourth, and fifth stage. Starting with a first stage of the molding process 300, the fabric blank 304 is received by the mold 200, depicted in FIGS. 3 and 4. Optionally, the second stage involves attaching a heat shield 308 to a side of fabric blank 304 that is exposed to the second mold base 208. The heat shield 308 may be reusable throughout multiple molding processes 300, and as such the heat shield 308 is a polyester film made of PET or biaxially-oriented PET (BoPET), known by the tradename Mylar®, or a similar substance having similar properties.

The third stage involves moving either the first mold base 204 or the second mold base 208 toward one another, thereby forming a molding compress 312, or a closed mold. As the first mold base 204 and the second mold base 208 are moved together, the first mold core 212 and the second mold core 216 mesh together and pinch the fabric blank 304, locking the fabric blank 304 in place.

As the first mold base 204 and the second mold base 208 continue to move toward one another, one of the first mold core 212 or the second mold core 216 begin to retreat within the first mold base 204 or the second mold base 208. As the first mold core 212 or second mold core 216 continue to retreat within the first mold base 204 or the second mold base 208 respectively, the fabric blank 304 is drawn into a more and more tensioned state. As described above, the variable height of the first mold core 212 and the second mold core 216 aid in the creation of zonal tensioning on the fabric blank 304.

During the third stage, the carrier 116 is created through injection of a liquid material, such as a thermoplastic material, through the carrier cavity 252 designed and arranged to be filled with the liquid material. As described above, the thermoplastic material may flow through the carrier cavity 252, as well as through and around the fabric blank 304 stretched across the carrier cavity 252. Further, cooling lines may be installed throughout the molding compress 312, either in the first mold base 204, the second base mold 208, or both. The cooling lines are designed to remove heat from certain areas or portions of the mold at certain times within the molding process 300. For example, cooling lines may be designed to manufacture the integral carrier 116 with thinner and more flexible sections, or thicker and less flexible sections. In addition, the cooling lines may be designed to prevent annealing portions of the fabric blank 304.

Next, the fourth stage of the molding process 300 includes opening the molding compress 312 and removing or ejecting a seat assembly 316, which includes the carrier 116 molded to the fabric blank 304, from the first mold base 204 or the second mold base 208. As described above, the first mold core 212 or the second mold core 216 may return to the original position, which may aid in the removal of the final product from the mold 200. At this fourth stage, excess fabric 320 is present in the seat assembly 316 and optionally the heat shield 308 remains secured to the fabric blank 304.

Finally, the fifth stage of the molding process 300 involves removing the excess fabric 320 from the seat assembly 316 and optionally separating the heat shield 308 from the fabric blank 304. The heat shield 308 may then be used in another molding process 300, or it may be shipped as part of the seat assembly 316 to be removed or discarded by an end user. For example, the heat shield 308 may have aesthetic features that make it desirable to include with a shipment of the seat assembly 316 to an end user, such as bearing a company logo, color, phrasing, shape, or other non-functional purpose.

It is contemplated that the seat assembly described herein may be used in a variety of applications, such as in furniture for residential, commercial, entertainment, transportation, or office applications. Alternatively, the described seat assembly may have broader applications, such as in industrial machinery, outdoor sporting equipment, or recreational equipment. For example, the seat assembly described herein can be applied to office furniture, automotive vehicles, airplanes, lawn mowers, watercraft, stadium seats, trampolines, or theaters.

While various spatial and directional terms, such as top, bottom, lower, mid, lateral, horizontal, vertical, front, rear and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the examples disclosed and defined herein extend to all alternative combinations of two or more of the individual features mentioned or evident from the text and/or drawings. All of these different combinations constitute various alternative aspects of the present disclosure. The claims are to be construed to include alternative examples to the extent permitted by the prior art.

1. A seat assembly, comprising:
a fabric component defining a seat surface; and
a carrier molded to the fabric component,
wherein the carrier includes a curved parting line that circumscribes a perimeter of the carrier, and
wherein the fabric includes a plurality tension zones.

2. The seat assembly of claim 1, wherein the carrier comprises an upper section and a lower section, and
wherein the parting line is disposed therebetween.

3. The seat assembly of claim 2, wherein a distance between an upper surface of the upper section, opposite the parting line, and the parting line is variable along the parting line.

4. The seat assembly of claim 2, wherein a thickness of the upper section is variable along a perimeter of the upper section.

5. The seat assembly of claim 2, wherein a thickness of the lower section is variable along a perimeter of the lower section.

6. The seat assembly of claim 1, wherein the fabric component least partially comprises a resin material.

7. The seat assembly of claim 1, wherein the carrier at least partially comprises a material having a melting temperature that is greater than a melting temperature of the material of the fabric component.

8. The seat assembly of claim 1, wherein two of the tension zones are configured to receive and support different amounts of weight.

9. The seat assembly of claim 1, wherein the fabric is pre-tensioned prior to the molding of the carrier to the fabric.

10. The seat assembly of claim 1, wherein the curved parting line defines a plurality of inflection points.

11. A seat assembly, comprising:
a fabric component having a seat surface; and
a carrier molded to the fabric component,
wherein the carrier includes a curved parting line along a perimeter of the carrier, and
wherein the curved parting line defines a plurality of inflection points.

12. The seat assembly of claim 11, wherein the fabric component includes a plurality of tension zones resulting from the curved parting line.

13. The seat assembly of claim 11, wherein the carrier comprises an upper section and a lower section, and
wherein the parting line is disposed therebetween.

14. The seat assembly of claim 13, wherein a thickness of the upper section or the lower section is variable along a perimeter of the upper section.

15. The seat assembly of claim 11, wherein the fabric component is knit.

16. A method of manufacturing a seat assembly, the method comprising:
tensioning a fabric component between a first mold base and a second mold base; and
molding a carrier onto the fabric component;
wherein the carrier includes a curved parting line around a perimeter of the carrier, and
wherein the fabric is tensioned to include a plurality of tension zones.

17. The method of claim 16, wherein the carrier comprises an upper section and a lower section, and
wherein the parting line is disposed therebetween.

18. The method of claim 17, wherein a height of the first mold base or the second mold base is variable.

19. The method of claim 18, wherein the carrier is formed within a cavity defined between the first mold base or the second mold base.

20. The method of claim 16, wherein the curved parting line is formed by an undulating cavity between the first mold base or the second mold base.
